(19) United States
(12) Patent Application Publication
(10) Pub. No.: US 2025/0371910 A1
(43) Pub. Date: Dec. 4, 2025

(54) AUTHENTICATION IMAGE ACQUISITION DEVICE, AUTHENTICATION IMAGE ACQUISITION METHOD, AND AUTHENTICATION IMAGE ACQUISITION PROGRAM

(71) Applicant: PANASONIC INTELLECTUAL PROPERTY MANAGEMENT CO., LTD., Osaka (JP)

(72) Inventors: Yangping SHEN, Kanagawa (JP); Hideyuki NAKAMURA, Fukuoka (JP); Yasunori WATANABE, Fukuoka (JP)

(73) Assignee: PANASONIC INTELLECTUAL PROPERTY MANAGEMENT CO., LTD., Osaka (JP)

(21) Appl. No.: 18/998,902

(22) PCT Filed: Jul. 31, 2023
(86) PCT No.: PCT/JP2023/028033

§ 371 Date: Mar. 24, 2025

(30) Foreign Application Priority Data
Jul. 29, 2022 (JP) 2022-121868

(51) Int. Cl. G06V 40/60; G06V 10/74; G06V 40/12; G06V 40/16

(52) U.S. Cl. CPC G06V 40/67; G06V 10/761; G06V 40/1365; G06V 40/172; G06V 2201/07

(57) ABSTRACT

An authentication image acquisition device includes: a first imaging unit configured to capture an image of a target person to be authenticated; a generation unit configured to generate a guide image in which an imaging guide for guiding the target person to an imaging position is superimposed on a first captured image obtained by the first imaging unit; an acquisition unit configured to acquire information on the target person based on the first captured image; and a display unit configured to display the guide image. The generation unit is configured to generate an imaging guide having a size based on the information on the target person and superimpose the imaging guide on the first captured image.

### TECHNICAL FIELD

The present disclosure relates to an authentication image acquisition device, an authentication image acquisition method, and an authentication image acquisition program.

### BACKGROUND ART

In recent years, biometric authentication techniques including face authentication and the like have been used for personal authentication in airports and the like. Patent Literature 1 is disclosed in the related art as an example of acquiring a captured image of a living body (for example, a face, a hand, or a finger) to be authenticated. In Patent Literature 1, a data registration device displays a biometric guide figure indicating a biometric shape on a display unit to capture an image of a subject, determines whether a capturing environment of a living body is appropriate based on a biometric region which is a region in the biometric guide figure in captured second output data, and registers the captured second output data when it is determined that the capturing environment is appropriate.

### CITATION LIST

### Patent Literature

Patent Literature 1: JP2021-131737A

### SUMMARY OF INVENTION

### Technical Problem

In personal authentication, a size of a living body used for authentication varies depending on a person (for example, an adult and a child). Therefore, when a biometric guide figure of the same size is displayed, the subject is required to move closer to or farther from a camera to match the size of the biometric guide figure displayed on the display unit. In particular, when the subject is a small infant, a size of a living body may not correspond to the size of the biometric guide figure unless the subject comes very close to the camera.

However, when the subject is too close to or too far from the camera in order to match the size of the displayed biometric guide figure, a position of the living body may be outside a depth of field of the camera. Accordingly, the data registration device has a problem that a burden on the subject increases or it is difficult to acquire image data suitable for biometric authentication due to a failure in biometric authentication, re-imaging of a living body, or the like.

The present disclosure has been made in view of the above situations in the related art, and an object of the present disclosure is to provide an authentication image acquisition device, an authentication image acquisition method, and an authentication image acquisition program that guide a target person to a position where a captured image more suitable for authentication can be obtained in acquisition of a captured image of the target person used for authentication.

### Solution to Problem

The present disclosure provides an authentication image acquisition device including: a first imaging unit configured to capture an image of a target person to be authenticated; a generation unit configured to generate a guide image in which an imaging guide for guiding the target person to an imaging position is superimposed on a first captured image obtained by the first imaging unit; an acquisition unit configured to acquire information on the target person based on the first captured image; and a display unit configured to display the guide image, in which the generation unit is configured to generate an imaging guide having a size based on the information on the target person and superimpose the imaging guide on the first captured image.

The present disclosure provides an authentication image acquisition method performed by an authentication image acquisition device, the authentication image acquisition device being configured to acquire a captured image obtained by capturing an image of a target person to be authenticated, the authentication image acquisition method including: capturing an image of the target person; acquiring information on the target person based on a captured image; generating a guide image in which an imaging guide having a size based on the information on the target person and being for guiding the target person to an imaging position is superimposed on the captured image; and displaying the guide image.

The present disclosure provides an authentication image acquisition program for causing an authentication image acquisition device, which is a computer capable of acquiring a captured image obtained by capturing an image of a target person to be authenticated, to execute: a step of capturing an image of the target person; a step of acquiring information on the target person based on a captured image; a step of generating a guide image in which an imaging guide having a size based on the information on the target person and being for guiding the target person to an imaging position is superimposed on the captured image; and a step of displaying the guide image.

### Advantageous Effects of Invention

According to the present disclosure, in acquisition of a captured image of the target person used for authentication, the target person can be guided to a position where a captured image more suitable for authentication can be obtained.

### BRIEF DESCRIPTION OF DRAWINGS

FIG. 1 is an explanatory diagram showing an example of an entire authentication system according to Embodiment 1;

FIG. 2 is a block diagram showing an example of a functional configuration of an authentication terminal according to Embodiment 1;

FIG. 3A is a diagram showing an example of a data table according to Embodiment 1;

FIG. 3B is a diagram showing an example of the data table according to Embodiment 1;

FIG. 4A is a diagram showing an example of a guide frame according to Embodiment 1;

FIG. 4B is a diagram showing an example of the guide frame according to Embodiment 1;

FIG. 4C is a diagram showing an example of the guide frame according to Embodiment 1;

FIG. 4D is a diagram showing an example of the guide frame according to Embodiment 1;

FIG. 5 is a flowchart showing a guide adjustment processing example according to Embodiment 1;

FIG. 6 is a flowchart showing a guide adjustment processing example according to Embodiment 1;

FIG. 7 is a flowchart showing a guide adjustment processing example according to Embodiment 2;

FIG. 8A is a diagram illustrating a positional relationship among an authentication terminal, scales (fixed reference objects) on a floor surface, and a target person in Embodiment 3;

FIG. 8B is a diagram illustrating a positional relationship among two imaging units, the scales (fixed reference objects) on the floor surface, and the target person in Embodiment 3;

FIG. 8C is a diagram illustrating a use case of an authentication system in Embodiment 3;

FIG. 9 is a flowchart showing a guide adjustment processing example according to Embodiment 3;

FIG. 10 is a flowchart showing a guide adjustment processing example according to a modification of Embodiment 3;

FIG. 11 is a diagram illustrating an example of an attribute information input screen;

FIG. 12A is a diagram showing an example of a display screen; and

FIG. 12B is a diagram showing an example of a display screen.

### DESCRIPTION OF EMBODIMENTS

Hereinafter, embodiments in which configurations and operations of an authentication image acquisition device, an authentication image acquisition method, and an authentication image acquisition program according to the present disclosure are specifically disclosed will be described in detail with reference to the drawings as appropriate. However, unnecessarily detailed descriptions may be omitted. For example, the detailed descriptions of well-known matters and the redundant description of substantially the same configuration may be omitted. This is to avoid unnecessary redundancy of the following descriptions and to facilitate understanding of those skilled in the art. The accompanying drawings and the following description are provided for those skilled in the art to fully understand the present disclosure, and are not intended to limit the subject matters described in the claims.

### Embodiment 1

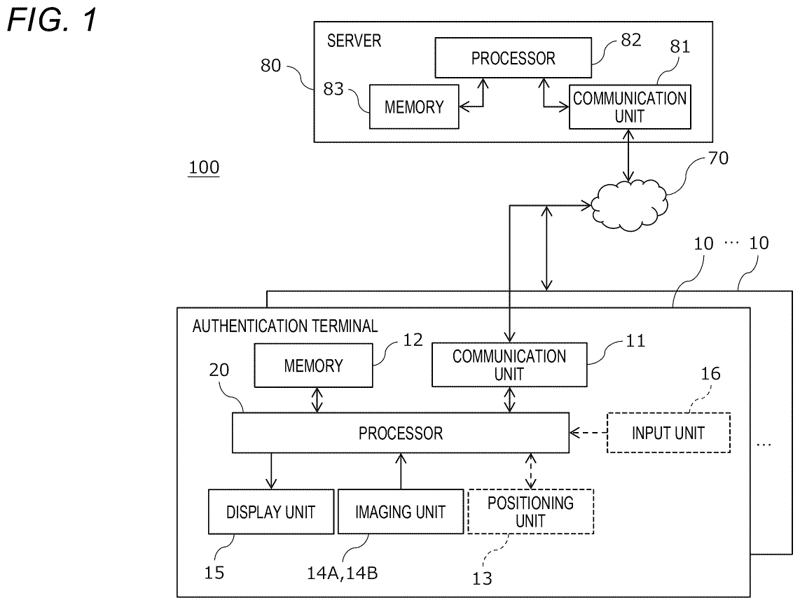

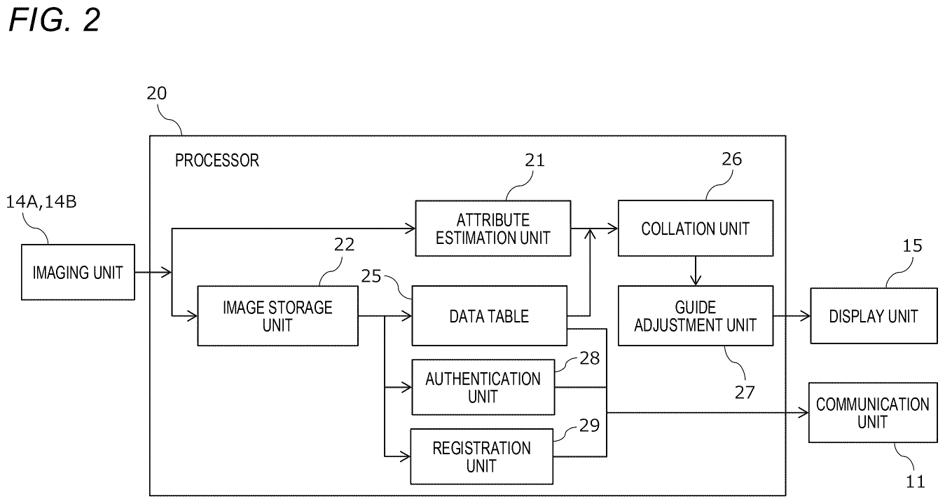

Hereinafter, Embodiment 1 will be described with reference to FIGS. 1 to 6. FIG. 1 is a system configuration diagram of an authentication system 100 according to Embodiment 1. FIG. 2 is a block diagram showing an example of a functional configuration of an authentication terminal 10 according to Embodiment 1. The authentication system 100 according to Embodiment 1 includes a server 80 and a plurality of authentication terminals 10. The configuration of the authentication system 100 shown in FIG. 1 is an example, and the present disclosure is not limited thereto.

In the example described in Embodiment 1, a size of a guide frame is adjusted based on attribute information (for example, a race, a gender, an age, and the like of a person) on a target person to be authenticated. Accordingly, the authentication system 100 can be used for applications such as authentication at an airport gate and authentication at an online bank. 5

The authentication system 100 according to Embodiment 1 includes the server 80, the authentication terminals 10, and a network 70. The server 80 and the plurality of authentication terminals 10 are connected via the network 70 so as to be able to perform wireless communication or wired communication, and transmit and receive data. Here, the wireless communication is, for example, communication via a wireless local area network (LAN) such as Wi-Fi (registered trademark).

The server 80 as an example of the authentication system 100 is connected to each of the plurality of authentication terminals 10 via the network 70 so as to be able to transmit and receive data.

The server 80 includes a communication unit 81, a processor 82, and a memory 83.

The communication unit 81 transmits and receives data to and from each of the plurality of authentication terminals 10 via the network 70.

The processor 82 is implemented by using, for example, a central processing unit (hereinafter, referred to as a “CPU”) or a field programmable gate array (hereinafter, referred to as an “FPGA”), and executes various processing and controls related to authentication processing of the target person in cooperation with the memory 83. The processor 82 executes, for example, processing of calculating a feature of the target person from a captured image and collating the feature with features of a plurality of persons stored in the memory 83 to perform authentication.

The memory 83 includes a recording device including a semiconductor memory such as a random access memory (hereinafter, referred to as a “RAM”) and a read only memory (hereinafter, referred to as a “ROM”) and any storage device such as a solid state drive (hereinafter, referred to as an “SSD”) or a hard disk drive (hereinafter, referred to as an “HDD”). The memory 83 stores a registered image of a face, a registered image of a hand, a data table 25, and the like used for authentication.

The server 80 uploads and downloads various data based on a request (control command) transmitted from the authentication terminal 10. For example, the server 80 starts authentication based on an authentication request (control command) received from the authentication terminal 10. The server 80 executes processing of performing authentication by collating a captured image obtained by capturing an image of a biometric part such as a face or a hand of the target person with captured images of faces or hands registered in memory 83 and transmitting an authentication result to the authentication terminal 10, processing of transmitting the data table 25 of a guide frame 30 for each attribute based on the authentication result to the authentication terminal 10, and the like.

The authentication terminal 10 as an example of an authentication image acquisition device is implemented by, for example, a stationary computer terminal, a personal computer (hereinafter, referred to as “PC”), a notebook PC, a tablet terminal, a smartphone, or the like. The authentication terminal 10 is connected to the server 80 via the network 70 so as to be able to transmit and receive data.

The authentication terminal 10 includes a communication unit 11, a processor 20, a memory 12, one or more imaging units 14A and 14B, and a display unit 15. The authentication terminal 10 may include a positioning unit 13 and an input unit 16. Although not illustrated in FIG. 1, the authentication terminal 10 may include a plurality of display units 15. The display unit 15, the imaging units 14A and 14B, or other components of the authentication terminal 10 may be provided separately, and may be installed at a location physically separated from a main body of the authentication terminal 10.

The communication unit 11 transmits and receives data to and from the server 80 via the network 70.

The processor 20 is implemented by using, for example, a CPU or an FPGA, and executes various processing and controls in cooperation with the memory 12. Specifically, the processor 20 implements each function used for authentication by referring to a program and data stored in the memory 12 and executing the program.

The memory 12 includes a recording device including a semiconductor memory such as a RAM and a ROM and any storage device such as an SSD or an HDD, and records the data table 25 for changing a size of the guide frame 30 to be described later.

The imaging units 14A and 14B are each, for example, a so-called camera that includes a solid-state imaging element such as a charged-coupled device (CCD) or a complementary metal oxide semiconductor (CMOS), and a lens, and convert an optical image formed on an imaging surface into an electric signal. The imaging units 14A and 14B output captured images to the processor 20. The imaging unit 14A is an example of a first imaging unit. The imaging unit 14B is an example of a second imaging unit.

The display unit 15 as an example of an output unit is implemented by using, for example, a display such as a liquid crystal display (LCD) or an organic electroluminescence (EL). The display unit 15 displays various screens output from the processor 20.

The input unit 16 is an interface implemented by using, for example, a touch panel, a keyboard, or a mouse. The input unit 16 receives an input operation performed by the target person, converts the received input operation into an electric signal (control command), and outputs the electric signal to the processor 20. When the input unit 16 is implemented by using a touch panel, the input unit 16 may be integrated with the display unit 15.

The input unit 16 may be a device such as an IC card reader, and may read attribute information on the target person from an IC chip incorporated in an identification card such as a passport, a driver license, or an employee ID card and output the attribute information to the processor 20.

The positioning unit 13 as an example of a measurement unit is, for example, a light detection and ranging (LiDAR), a millimeter wave radar, or a stereo camera, and measures a distance between the authentication terminal 10 and the target person, and outputs the distance to the processor 20.

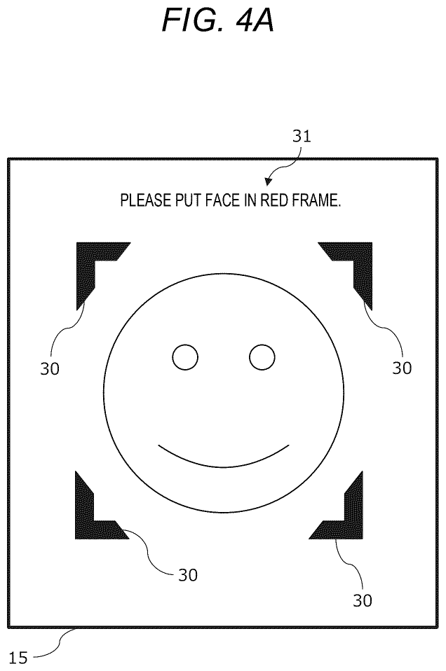

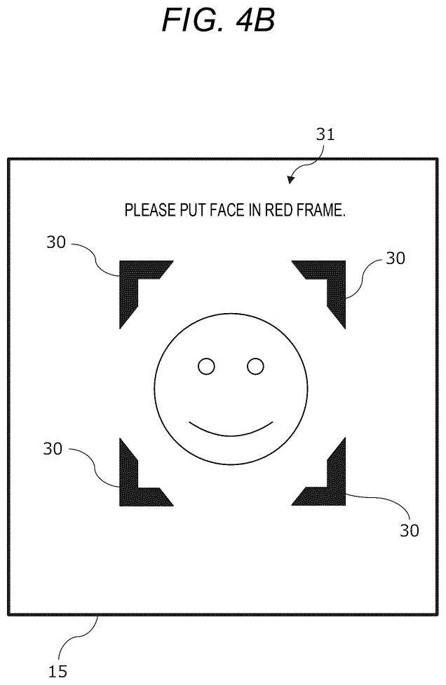

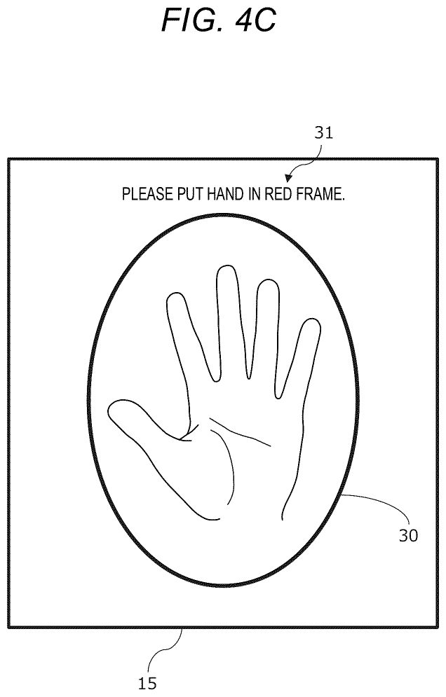

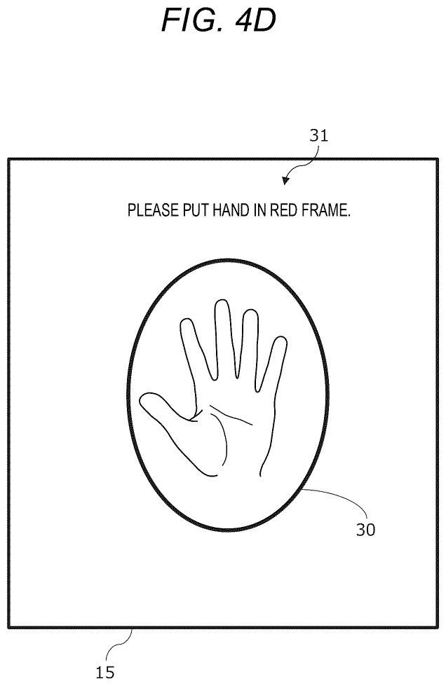

Next, the guide frame 30 displayed on the display unit 15 of the authentication terminal 10 will be described with reference to FIGS. 4A to 4D. The guide frame 30 is displayed on the display unit 15 to guide the target person to a position where the imaging unit 14A can more appropriately capture an image of the target person that can be used for biometric authentication. FIG. 4A is a diagram showing an example of the guide frame 30 according to Embodiment 1.

FIG. 4A is a diagram showing a display example of a guide screen displayed on display unit 15 of the authentication terminal 10. The display unit 15 shown in FIG. 4A displays a face image (example of a guide image) in which the guide frame 30 is superimposed on a captured image of the target person obtained by the imaging unit 14A. The face image is generated by the processor 20 and displayed on the display unit 15. In this way, by displaying the face image in which the guide frame 30 is superimposed on the captured image of the target person on the display unit 15, the authentication terminal 10 can prompt the target person to move such that a size of the face corresponds to a size of the guide frame 30.

The authentication terminal 10 displays, on the display unit 15 in a superimposed manner, a message 31 “PLEASE PUT FACE IN RED FRAME.”, which prompts the target person to put the face within the guide frame 30. Accordingly, the authentication terminal 10 can prompt the target person to move such that a contour of the face of the target person fits in the guide frame 30.

The size of the guide frame 30 is variable. For example, in an example of FIG. 4B, the guide frame 30 smaller than the guide frame 30 shown in FIG. 4A is displayed. FIG. 4B is a diagram showing an example of the guide frame 30 according to Embodiment 1.

When the guide frame 30 is changed to the guide frame 30 having a smaller shape, a display position of the guide frame 30 on the display unit 15 may be not only a central portion of the display unit 15, but may also be a position offset in an up-down or left-right direction. The determination of the display position will be described later.

A shape of the guide frame 30 is not limited to a hook shape shown in FIG. 4A, and may be, for example, a rectangular shape, a circular shape, or an elliptical shape.

The guide frame 30 may be a guide that guides a position of the hand of the target person as in examples shown in FIGS. 4C and 4D. FIG. 4C is a diagram showing an example of the guide frame 30 according to Embodiment 1. FIG. 4D is a diagram showing an example of the guide frame 30 according to Embodiment 1. When the position of the hand is guided, the display unit 15 displays a hand image in which the guide frame 30 is superimposed on a captured image obtained by capturing an image of the hand of the target person. Similarly to the face image, the hand image is generated by the processor 20 and displayed on the display unit 15.

Next, an operation of an attribute estimation unit 21, which is a function performed by the processor 20, will be described. The processor 20 estimates and extracts attribute information on the target person such as a nationality, a race, a gender, and an age of the target person using the captured image obtained by the imaging unit 14A.

When estimating the attribute information on the target person using the captured image obtained by capturing an image of the face of the target person, the attribute estimation unit 21 as an example of an acquisition unit estimates the attribute information such as the race, the gender, and the age of the target person using an artificial intelligence (hereinafter, referred to as “AI”) technology such as an image processing technology using deep learning or machine learning. For example, the attribute estimation unit 21 executes image processing on the captured image of the target person using a learned attribute estimation model, and acquires an estimation result of the attribute information output from the attribute estimation model. The estimation result is data (information) directly or indirectly indicating the attribute information on the target person.

Similarly, when the attribute estimation unit 21 estimates the attribute information on the target person using the captured image obtained by capturing an image of the hand of the target person, the attribute estimation unit 21 estimates the attribute information such as the race, the gender, and the age of the target person using the AI technology or the like. Here, the captured image used for the estimation may be a captured image obtained by capturing an image of a palm side of the hand of the target person or a captured image obtained by capturing an image of a back side of the hand.

When a captured image obtained by capturing an image of an identification is used, the attribute estimation unit 21 acquires the attribute information such as the nationality, the gender, and the age of the target person using the AI technology, a character recognition technology, or the like.

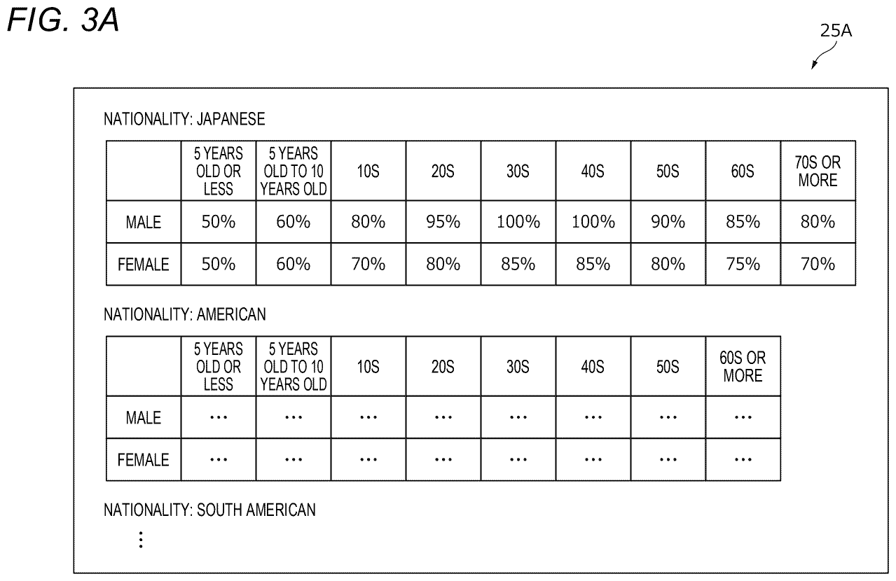

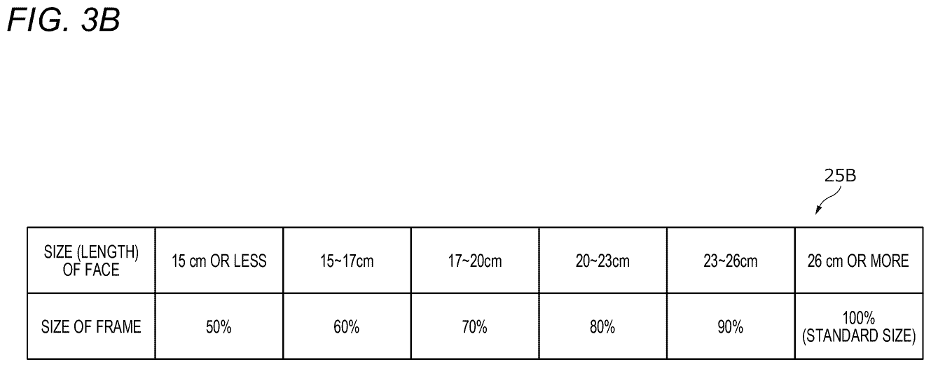

Next, the data table 25 referred to by the processor 20 in adjustment processing of the guide frame 30 to be described later will be described with reference to FIGS. 3A and 3B. FIG. 3A is a diagram showing an example of a data table 25A according to Embodiment 1. FIG. 3B is a diagram showing an example of a data table 25B according to Embodiment 1.

The data table 25 is stored in the memory 12 of the authentication terminal 10 and referred to by the processor 20. When the data tables 25A and 25B recorded in the data table 25 are to be updated from the server 80 via the network 70, the processor 20 of the authentication terminal 10 acquires update data of the data table 25 transmitted from the server 80, and updates the data table 25 in the memory 12 to the acquired update data of the data table 25.

The data table 25A shown in FIG. 3A is data in which the attribute information on the target person and size information (size) of the guide frame 30 are associated with each other, and is data in which each attribute information (that is, the gender, the age, the nationality, or the like of the target person) and the size information on the guide frame 30 superimposed on the captured image of the target person are associated with each other. A standard size is indicated by “100%” in the data table 25A. Specifically, the data table 25 records information indicating that when the nationality, the gender, and the age in the attribute information on the target person are “Japanese”, “female”, and “60s”, respectively, the guide frame 30 having a size that is 75% of the standard size (100%) is superimposed on the captured image.

Here, each attribute information and the size information on the guide frame 30 associated with each other in the data table 25A are determined based on a (relative) size of the face or the hand of the target person in the captured image obtained by the imaging unit 14A when a distance between the imaging unit 14A and the face or the hand of the target person is within a depth of field of the imaging unit 14A. That is, when the face or the hand of the target person is large, a proportion of the face or the hand in the captured image obtained by the imaging unit 14A is large, and when the face or the hand of the target person is small, the proportion of the face or the hand in the captured image obtained by the imaging unit 14A is small, so that the authentication terminal 10 sets the size (size information) of the guide frame 30 to be superimposed on a captured image of each target person according to the size of the face or the hand of the target person based on the attribute information on the target person.

Each item related to the attribute information of the data table 25A may be changed by a configuration of the authentication system 100 using the item. For example, when the attribute information on the target person based on the captured image obtained by capturing an image of the face of the target person is acquired, the information on the item “NATIONALITY” in the attribute information may be omitted. In addition, for example, when the attribute information on the target person is acquired from the captured image obtained by capturing an image of the hand of the target person, the information on the item “NATIONALITY” or “gender” in the attribute information may be omitted.

The data table 25B shown in FIG. 3B is data in which a size (length) of the face of the target person shown in the captured image and the size information on the guide frame 30 are associated with each other. The item “SIZE OF FACE” included in the data table 25B is not limited to the length of the face of the target person (length from a top of a head to a jaw), and may be a width of the face or an area of the face.

In the data table 25B, an example in which the size (length) of the face of the target person and the size information on the guide frame 30 are associated with each other is shown, but the size (length), the area, or the like of the hand of the target person may be associated with the size information on the guide frame 30. Accordingly, the authentication terminal 10 can acquire the size information on guide frame 30 based on the size (length), the area, or the like of the hand of the target person.

Next, an operation of a collation unit 26, which is a function performed by the processor 20, will be described.

The collation unit 26 collates the data table 25 using the attribute information estimated by the attribute estimation unit 21, and acquires the size information on the guide frame 30 superimposed on the captured image.

The collation unit 26 may collate the data table 25 using the attribute information acquired by the input unit 16, and acquire the size information on the guide frame 30 superimposed on the captured image (information on a relative size of the guide frame 30 with respect to the standard size of the guide frame 30). For example, when the input unit 16 receives an input operation performed by the target person, the collation unit 26 may refer to the data table 25 using information (attribute information) input to the input unit 16, and, for example, when the input unit 16 is an IC card reader, the collation unit 26 may refer to the data table 25 using information (attribute information) read from an IC card and acquire the size information on the guide frame 30 superimposed on the captured image.

Next, an operation of a guide adjustment unit 27, which is a function performed by the processor 20, will be described. The guide adjustment unit 27 determines the generation of the guide frame 30 and the display position of the guide frame 30 on the display unit 15.

The guide adjustment unit 27 as an example of a generation unit creates the guide frame 30 based on the size information output from the collation unit 26. The guide adjustment unit 27 deforms the guide frame 30 having a predetermined standard size into a size of the guide frame 30 based on the size information obtained from the collation unit 26.

The guide adjustment unit 27 may change the size of the guide frame 30 without using the size information output from the collation unit 26. When the area (size) of the face or the hand of the target person can be estimated, the guide adjustment unit 27 generates the guide frame 30 having a size corresponding to the estimated area (size) of the face or the hand. In this case, the guide adjustment unit 27 reduces the size of the guide frame 30 as the estimated area (size) of the face or the hand of the target person is smaller. Accordingly, it is possible to prevent a target person having a small face or hand from coming too close to the imaging unit 14A and deviating from the depth of field of the imaging unit 14A.

Next, the guide adjustment unit 27 determines the display position of the guide frame 30 displayed on the display unit 15. When a display region of the display unit 15 capable of displaying the captured image (face image or hand image) corresponds to an angle of view of the imaging unit 14A, the captured image (face image or hand image) is displayed at a center position of the display region, and the guide frame 30 is displayed at the central portion of the display unit 15, the imaging unit 14A can capture an image of the target person at a central portion of a lens (not shown). Accordingly, the authentication terminal 10 can capture an image of the target person in the central portion of the lens with small lens distortion, and thus the authentication accuracy of personal authentication using the captured image obtained by capturing an image of the face or the hand can be improved.

The guide frame 30 may be displayed not only at the central portion of the display unit 15 but also at a position offset in the up-down or left-right direction. When the size (length) of the face of the target person can be estimated, the guide adjustment unit 27 refers to the data table 25B shown in FIG. 3B and creates the guide frame 30 having a size suitable for the estimated size (length) of the face. In this case, the guide adjustment unit 27 changes the relative size of the guide frame 30 based on the estimated size (length) of the face of the target person. There is a correlation between the area (size) of the face and a height of the target person, and for example, there is a high possibility that a young person or an elderly person has a small face size and is short in height. Therefore, when it is estimated that the target person is an elderly person or a young person, the authentication terminal 10 can capture an image of the target person without imposing a burden such as a back stretch, by displaying the guide frame 30 with the display position thereof offset to a lower side of the display unit 15. When the target person is tall, the authentication terminal 10 can capture an image of the target person without imposing a burden such as bending and stretching, by displaying the guide frame 30 with the display position thereof offset to an upper side of the display unit 15.

Next, an authentication unit 28, which is a function performed by the processor 20, will be described. The authentication unit 28 generates an authentication request including a captured image of a target person and a control command for requesting biometric authentication using the captured image. The processor 20 transmits the authentication request to the server 80 via the communication unit 11.

Next, a registration unit 29, which is a function performed by the processor 20, will be described. The registration unit 29 generates a registration request including a captured image of a target person (that is, a registered image of a face or a registered image of a hand) and a control command for requesting registration of the captured image. The processor 20 transmits the registration request to the server 80 via the communication unit 11.

Next, an image storage unit 22, which is a function performed by the processor 20, will be described. The image storage unit 22 temporarily stores the images acquired from the imaging units 14A and 14B.

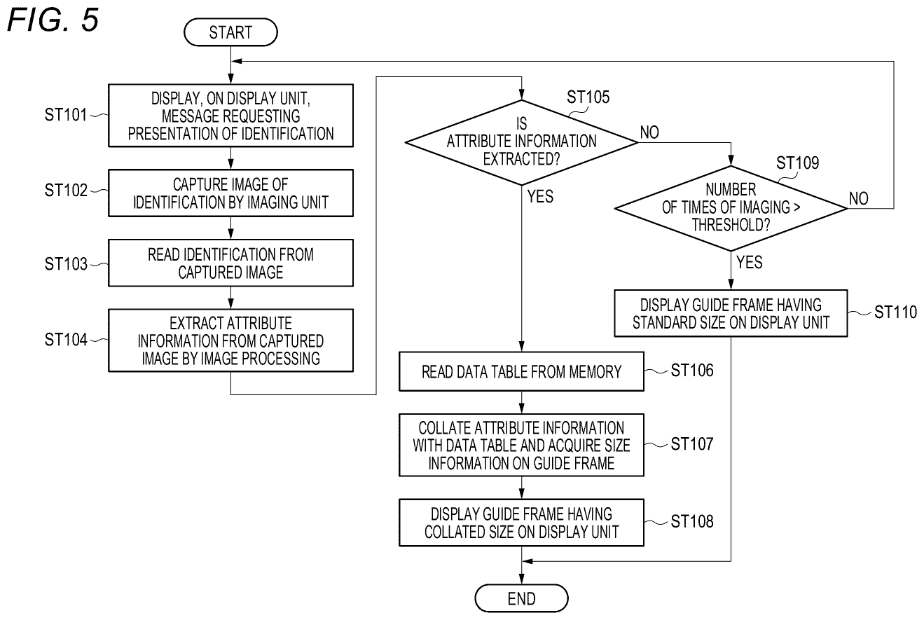

Next, an operation of the authentication system 100 according to Embodiment 1 will be described with reference to FIG. 5. FIG. 5 is a flowchart showing a guide adjustment processing example according to Embodiment 1. Some or all of processing of steps processed by the authentication terminal 10 may be executed by the server 80.

In the following description, in order to make the description easy to understand, an example of performing face authentication at an airport gate will be described.

The authentication terminal 10 displays, on the display unit 15, a message (not shown) requesting presentation of an identification (ST101).

The authentication terminal 10 captures an image of an identification presented by a target person by the imaging unit 14A (or the imaging unit 14B different from the imaging unit 14A) (ST102). Here, the identification is a driver license, a passport, a health insurance card, or the like.

The authentication terminal 10 detects the identification from the captured image and reads identification information described in the identification (ST103).

The authentication terminal 10 executes processing of extracting attribute information such as a nationality, a gender, and an age of the target person from the identification shown in the captured image (ST104), and determines whether the attribute information on the target person is estimated from the identification (ST105).

When it is determined that the attribute information is estimated (ST105, Yes), the authentication terminal 10 reads the data table 25A from the memory 12 (ST106), and acquires size information on the guide frame 30 superimposed on the captured image based on the extracted attribute information (ST107). The authentication terminal 10 adjusts a size of the guide frame 30 based on the acquired size information, generates a face image in which the guide frame 30 is superimposed on the captured image, and displays the face image on the display unit 15 (ST108).

When the authentication terminal 10 determines that the attribute information is not estimated from the identification (ST105, No), the processing proceeds to step ST109.

The authentication terminal 10 counts the number of times of imaging of the identification by the imaging unit 14A, and determines whether the counted current number of times of imaging exceeds a threshold (ST109). When the authentication terminal 10 determines that the current number of times of imaging does not exceed the threshold (ST109, No), the processing returns to step ST101 and repeatedly performs imaging.

On the other hand, when it is determined that the counted number of times of imaging exceeds the threshold (ST109, Yes), the authentication terminal 10 generates the guide frame 30 having a standard size, generates a face image in which the guide frame 30 is superimposed on the captured image, and displays the face image on the display unit 15 (ST110).

After step ST108 or step ST110, the authentication system 100 proceeds to processing of authenticating the target person by the server 80. As described above, the authentication system 100 according to Embodiment 1 acquires the attribute information on the target person from the identification, and acquires the size information on the guide frame 30 based on the acquired attribute information. The authentication system 100 displays, on the display unit 15, the face image in which the guide frame 30 generated based on the acquired size information is superimposed on the captured image, and thus can perform authentication using the captured image obtained by capturing an image of the target person within the depth of field of the imaging unit 14A.

### Modification of Embodiment 1

In the authentication system 100 according to Embodiment 1, an example in which the imaging unit 14A captures an image of the identification has been described. In the authentication system 100 according to a modification of Embodiment 1, an example of acquiring attribute information on a target person by another method such as an input operation of the attribute information performed by the target person or reading of an IC card will be described.

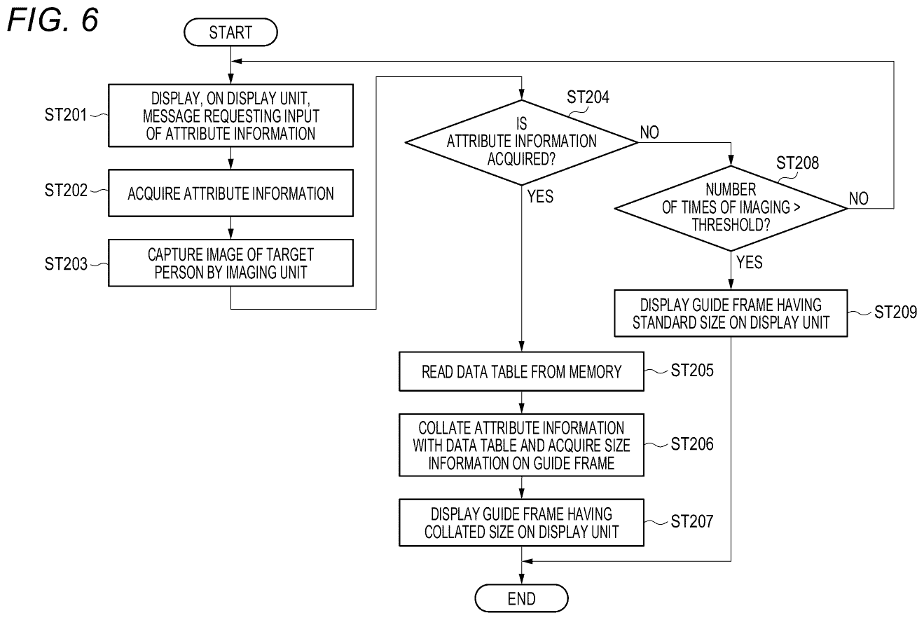

FIG. 6 shows a flowchart of receiving an input of the attribute information from the target person and displaying the guide frame 30 for capturing an image of a face of the target person. FIG. 6 is a flowchart showing a guide adjustment processing example according to Embodiment 1.

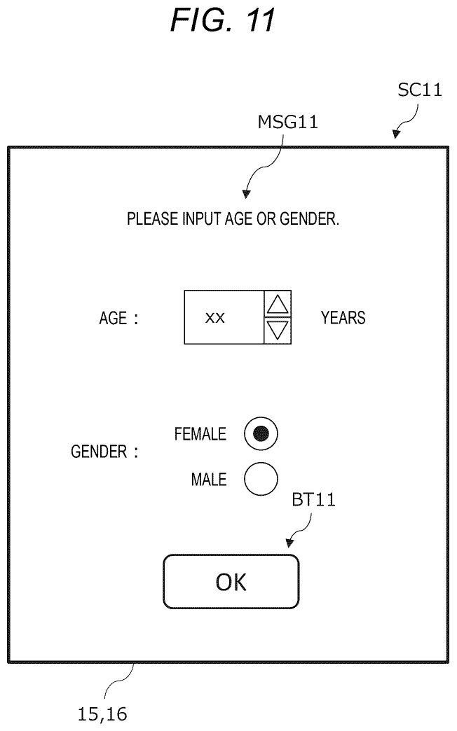

The authentication terminal 10 displays, on the display unit 15, an attribute information input screen SC11 (see FIG. 11) including a message MSG11 requesting an input of attribute information on a target person (ST201).

The authentication terminal 10 receives attribute information input to the input unit 16 (ST202).

The authentication terminal 10 captures an image of the target person by the imaging unit 14A (ST203). The imaging processing of the target person is not limited to a procedure (step ST203) shown in FIG. 6. The imaging processing may be executed at any timing between step ST201 to step ST206 or step ST201 to step ST208.

Based on the input attribute information, the authentication terminal 10 determines whether attribute information necessary for determining a size of the guide frame 30 is acquired (ST204).

When it is determined that the attribute information necessary for determining the size of the guide frame 30 is acquired (ST204, Yes), the authentication terminal 10 reads the data table 25A from the memory 12 (ST205).

The authentication terminal 10 collates the attribute information with the data table 25A and acquires size information on the guide frame 30 (ST206).

The authentication terminal 10 generates the guide frame 30 based on the size information on the guide frame 30, and displays, on the display unit 15, a face image in which the generated guide frame 30 is superimposed on the captured image (ST207).

When it is determined that the attribute information necessary for determining the size of the guide frame 30 is not acquired (ST204, No), the authentication terminal 10 counts the number of times of imaging of an identification by the imaging unit 14A and determines whether the counted current number of times of imaging exceeds a threshold (ST208). When the authentication terminal 10 determines that the current number of times of imaging exceeds the threshold (ST208, Yes), the processing returns to step ST201 and repeatedly performs imaging.

On the other hand, when it is determined that the counted number of times of imaging does not exceed the threshold (ST208, No), the authentication terminal 10 generates the guide frame 30 having a standard size, generates a face image in which the guide frame 30 is superimposed on the captured image, and displays the face image on the display unit 15 (ST209).

After step ST207 or step ST209, the authentication system 100 proceeds to processing of authenticating the target person by the server 80.

As described above, the authentication system 100 according to the modification of Embodiment 1 receives the input of the attribute information by the target person, and acquires the size information on the guide frame 30 based on the received attribute information. The authentication system 100 displays, on the display unit 15, the face image in which the guide frame 30 generated based on the acquired size information is superimposed on the captured image, and thus can perform authentication using the captured image obtained by capturing an image of the target person within a depth of field of the imaging unit 14A.

Here, the attribute information input screen SC11 displayed in step ST201 will be described with reference to FIG. 11. FIG. 11 is a diagram showing an example of the attribute information input screen SC11. The attribute information input screen SC11 shown in FIG. 11 is an example, and the present disclosure is not limited thereto.

The attribute information input screen SC11 is generated by the processor 20 and output (displayed) to the display unit 15. The attribute information input screen SC11 includes the message MSG11 “PLEASE INPUT AGE OR GENDER.”, which prompts the target person to perform an input operation of attribute information, an input item (input item of attribute information “age” or “gender” in the example shown in FIG. 11) capable of receiving an input of at least one piece of attribute information, and a button BT11.

When the button BT11 is pressed (selected) by the target person, the processor 20 acquires attribute information input to the input item of the attribute information input screen SC11 as the attribute information on the target person.

### Embodiment 2

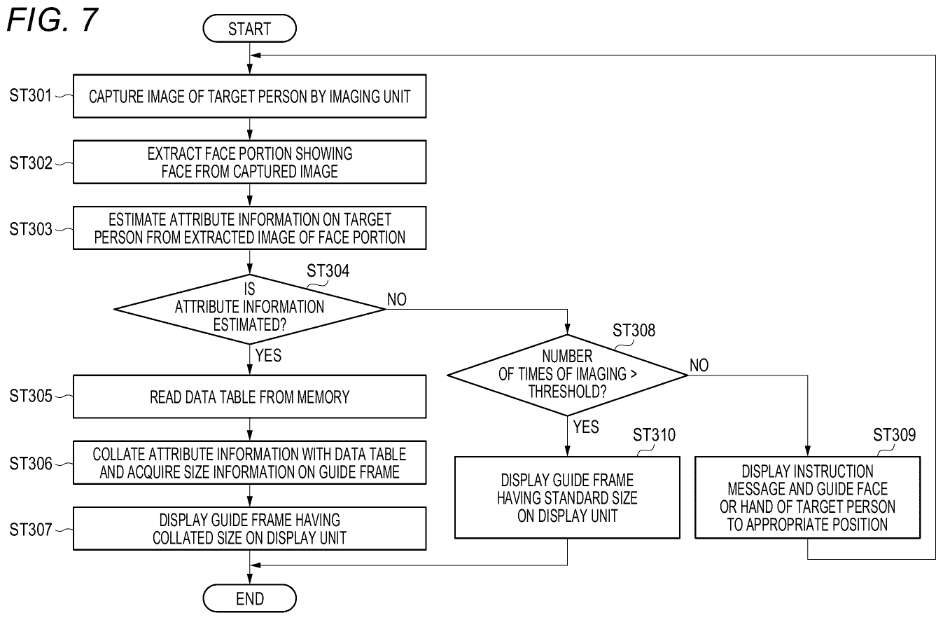

In the authentication system 100 according to Embodiment 1 described above, an example in which the attribute information on the target person is acquired based on the identification shown in the captured image or the input operation performed by the target person has been described. In the authentication system 100 according to Embodiment 2, an example in which attribute information on a target person is estimated and acquired based on a captured image obtained by capturing an image of the target person will be described. FIG. 7 shows a flowchart of capturing an image of a face of a target person, estimating attribute information on the target person from the captured face image, and displaying the guide frame 30. FIG. 7 is a flowchart showing a guide adjustment processing example according to Embodiment 2.

The authentication terminal 10 captures an image of a target person by the imaging unit 14A, and acquires a captured image obtained by capturing an image of a region including at least a part of a face of the target person (ST301).

The authentication terminal 10 detects the face of the target person based on the captured image, and extracts an image of a detected face portion from the captured image (ST302).

The authentication terminal 10 executes image processing on the extracted image of the face portion, and estimates attribute information on the target person (ST303).

When it is determined that the attribute information on the target person is estimated based on the image of the face portion (ST304, Yes), the authentication terminal 10 reads the data table 25A from the memory 12 (ST305).

The authentication terminal 10 refers to the data table 25A and acquires size information on the guide frame 30 based on the attribute information on the target person (ST306).

The authentication terminal 10 generates a size of the guide frame 30 based on the size information, generates a face image in which the guide frame 30 is superimposed on the captured image, and displays the face image on the display unit 15 (ST307).

On the other hand, when it is determined that the attribute information cannot be estimated based on the image of the face portion in step ST304 (ST304, No), the authentication terminal 10 counts the number of times of imaging of the target person by the imaging unit 14A, and determines whether the counted number of times of imaging exceeds a threshold (ST308). After the face image including a message is displayed, the authentication terminal 10 repeatedly performs re-imaging of the target person, but when it is determined that the counted number of times of imaging (that is, the number of times that the attribute information on the target person cannot be acquired) exceeds the threshold (ST308, Yes), the authentication terminal 10 determines the guide frame 30 to be superimposed on the captured image to be a standard size, generates an face image on which the guide frame 30 adjusted to the standard size is superimposed, and displays the face image on the display unit 15 (ST310).

When it is determined that the counted number of times of imaging (that is, the number of times that the attribute information on the target person cannot be acquired) does not exceed the threshold (ST308, No), the authentication terminal 10 generates a face image including the message 31, displays the face image on the display unit 15 (ST309), and starts processing of step ST301 again. Accordingly, the authentication terminal 10 can guide the target person to a position corresponding to a depth of field of the imaging unit 14A by displaying, on the display unit 15, the face image on which the guide frame 30 is superimposed. The message to be displayed here is not limited to the message 31, and may be generated based on a size of the face shown in the captured image. For example, when it is determined that a size of the face of the target person is large compared to a size of the displayed guide frame 30, the authentication terminal 10 generates and displays a message prompting a person to be authenticated to move away from the authentication terminal 10, and when it is determined that the face is small, the authentication terminal 10 generates and displays a message prompting the person to be authenticated to move closer to the authentication terminal 10.

After step ST307 or step ST310, the authentication system 100 proceeds to processing of authenticating the target person by the server 80.

As described above, the authentication system 100 according to Embodiment 2 acquires the attribute information on the target person based on the face of the target person shown in the captured image, and acquires the size information on the guide frame 30 based on the acquired attribute information. The authentication system 100 generates the guide frame 30 having a size based on the acquired size information, generates the face image in which the generated guide frame 30 is superimposed on the captured image, and displays the face image on the display unit 15, and thus can perform authentication using the captured image of the target person obtained in the depth of field of the imaging unit 14A.

Here, before capturing an image of the target person in step ST301, the guide frame 30 may be displayed on the display unit 15. In this case, the guide frame 30 displayed in advance is not limited to the attribute information on the target person, and is the guide frame 30 having a standard size.

Although the authentication system 100 according to Embodiment 2 described above adjusts the size of the guide frame 30 for obtaining the captured image of the target person using the face image for the purpose of authenticating the face of the target person, the captured image used for authentication of the target person is not limited to the face. A captured image obtained by capturing an image of a hand of the target person may be used. When the captured image of the hand of the target person is used, the attribute information on the target person may be estimated from the captured image obtained by capturing an image of the hand, and a size of the guide frame 30 superimposed on the hand image may be adjusted. Here, when the captured image of the hand is used, the attribute information (race, age, or gender) on the target person can be easily estimated by using a captured image on a back side of the hand.

In addition, in the authentication system 100 according to Embodiment 2 described above, the acquisition and adjustment of the size information on the guide frame 30 used for capturing an image of the face of the target person are performed using the attribute information estimated from the captured image obtained by capturing an image of the face of the target person, but the captured image for estimating the attribute information is not limited to the captured image showing the face, and the size information on the guide frame 30 for obtaining the captured image of the face of the target person used for authentication may be acquired by estimating the attribute information from the captured image obtained by capturing an image of the hand of the target person.

In addition, the attribute information may be acquired from the captured image of the

target person, and the guide frame 30 for obtaining the captured image of the hand of the target person used for authentication may be adjusted.

### Embodiment 3

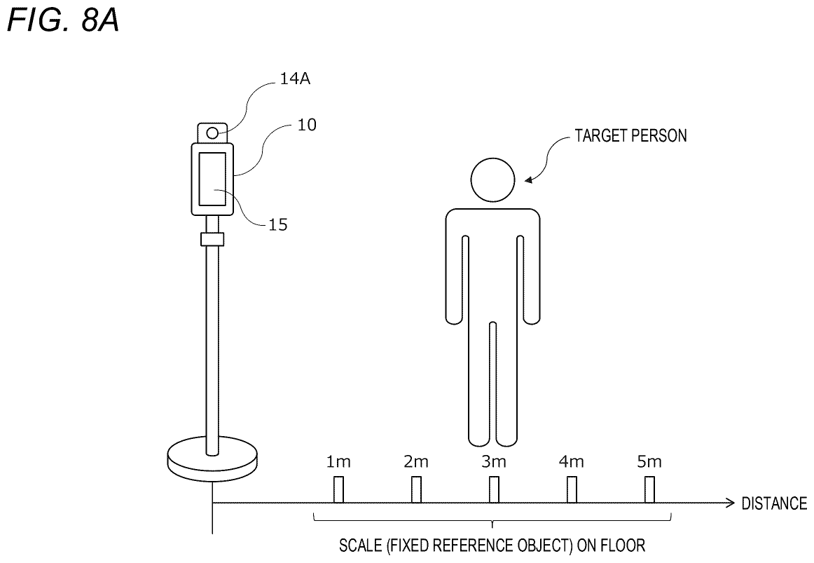

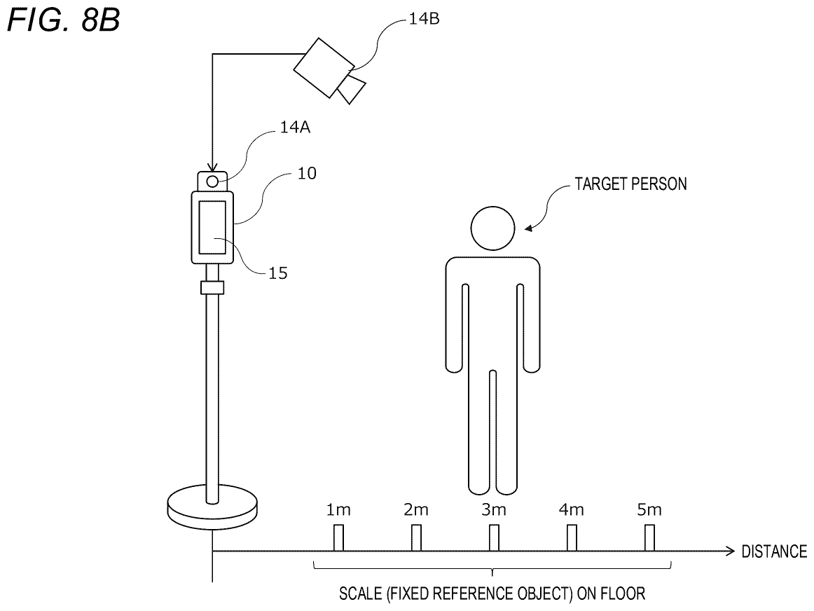

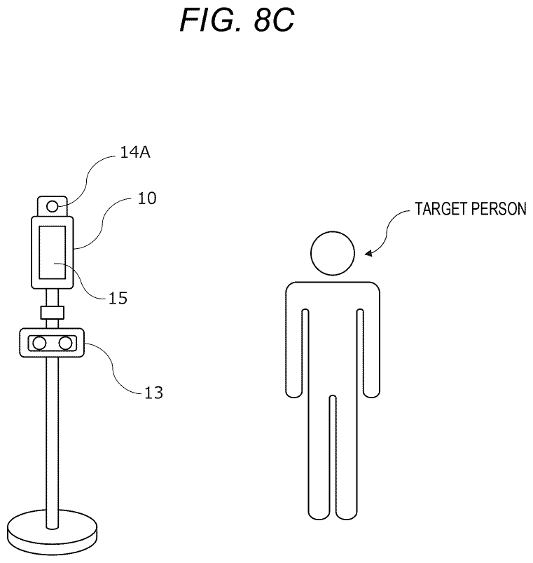

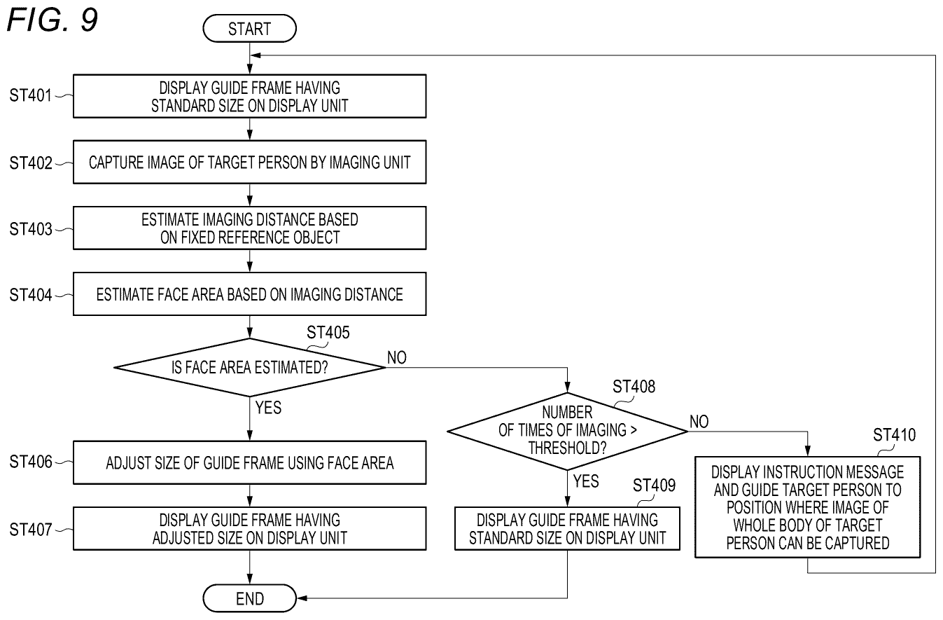

In the authentication system 100 according to Embodiment 2, an example in which the attribute information on the target person is estimated and acquired based on the target person shown in the captured image obtained by capturing an image of the target person has been described. In the authentication system 100 according to Embodiment 3, an example will be described in which an area (size) of a face of a target person is estimated using a captured image obtained by capturing an image of a region including a whole body of the target person and a background, and the guide frame 30 is generated according to the area (size) of the face. Hereinafter, Embodiment 3 will be described with reference to FIGS. 8A, 8B, and 9.

FIG. 8A is a diagram illustrating a positional relationship among the authentication terminal 10, scales (fixed reference objects) on a floor surface, and a target person in Embodiment 3. Each scale on the floor surface indicates a distance between the authentication terminal 10 and each scale, and is measured in advance.

In an example shown in FIG. 8A, the authentication terminal 10 captures an image of a target person present at a scale position at a distance of 3 m from the authentication terminal by the imaging unit 14A, and acquires a captured image including a whole body of the target person and a scale. 10

The authentication terminal 10 determines that the target person is present at the position of 3 m from the authentication terminal 10 by performing image analysis on the scale shown in the acquired captured image. The authentication terminal 10 derives an area (size) of a face of the target person and a height of the target person based on a relation between an imaging distance based on a position of the target person (that is, a distance between the imaging unit 14A and the target person) and a size (length) of the whole body of the target person in the entire captured image (that is, an angle of view of the imaging unit 14A). The scales on the floor surface may have different colors or different lengths. The authentication terminal 10 may store information on a color or a length of each scale set in advance and information on a distance between the authentication terminal 10 and the target person indicated by each scale in association with each other.

Here, the fixed reference object as an example of a fixed object is not limited to the scale on the floor surface shown in the example of FIG. 8A, and for example, a pattern of a floor board, a tile carpet in which a plurality of objects are arranged in different colors, furniture placed on a floor, a pot of a foliage plant, or the like may be used. In such a case, in the authentication terminal 10, a manager of the authentication terminal 10 may associate the distance between the target person and the authentication terminal 10 with a mark indicating each distance between the target person and the authentication terminal 10 (for example, a pattern of a floor board, a tile carpet, furniture, or a pot of a foliage plant). Accordingly, the authentication terminal 10 can detect a mark shown in a captured image and a target person, and estimate a distance between the authentication terminal 10 and the target person based on a positional relationship between the detected mark and target person.

FIG. 8B is a diagram illustrating a positional relationship between the two imaging units 14A and 14B, the scales (fixed reference objects) on the floor surface, and the target person in Embodiment 3. An example in which the authentication terminal 10 shown in FIG. 8B captures an image of the target person using each of the two imaging units 14A and 14B will be described.

The authentication terminal 10 includes the two imaging units 14A and 14B. The imaging unit 14A obtains a captured image used for authentication of the target person. The imaging unit 14A is disposed near the display unit 15 (that is, at a position close to a height of the face of the target person).

The imaging unit 14B obtains a captured image used for estimating a distance between the authentication terminal 10 and the target person. The imaging unit 14B is disposed at a position higher than a height of the target person (specifically, at a height of 2 m to 3 m from the floor surface), and captures an image of the target person and the fixed reference object in a manner of looking down.

FIG. 9 is a flowchart showing a guide adjustment processing example according to Embodiment 3. The flowchart shown in FIG. 9 is a flowchart of processing of estimating the area (size) of the face of the target person using the captured image obtained by capturing an image of the target person and the fixed reference object, and changing and displaying a size of the guide frame 30.

The authentication terminal 10 generates the guide frame 30 having a standard size, superimposes the generated guide frame 30 on a captured image, and displays the image on the display unit 15 (ST401).

The authentication terminal 10 captures an image of a whole body of a target person (ST402).

The authentication terminal 10 performs image analysis on the captured image, and detects the whole body of the target person and a fixed reference object. The authentication terminal 10 estimates a distance (imaging distance) between the authentication terminal 10 (imaging unit 14A or imaging unit 14B) and the target person based on a positional relationship between the detected whole body of the target person and the fixed reference object (ST403).

The authentication terminal 10 estimates an area (size) of a face of the target person based on the estimated imaging distance (ST404).

The authentication terminal 10 determines whether the area (size) of the face of the target person is estimated based on the captured image (ST405). When it is determined that the area (size) of the face of the target person is estimated (ST405, Yes), the authentication terminal 10 refers to the data table 25 and acquires size information on the guide frame 30 based on the estimated area (size) of the face. The authentication terminal 10 adjusts a size of the guide frame 30 based on the acquired size information (ST406).

The authentication terminal 10 generates a face image in which the guide frame 30 after the size adjustment is superimposed on the captured image, and displays the face image on the display unit 15 (ST407). The authentication terminal 10 may change a position of the face image displayed on the display unit 15 based on a height of the target person. For example, when it is determined that the target person is short, the authentication terminal 10 may display the face image on which the guide frame 30 is superimposed at a position below a center of the display unit 15. Accordingly, even when the target person is short, the authentication terminal 10 can capture an image without imposing a burden on the target person such as back stretching to fit the guide frame 30.

On the other hand, when it is determined that the area (size) of the face is not estimated in step ST404 (ST405, No), the authentication terminal 10 counts the number of times of imaging of the target person by the imaging unit 14A, and determines whether the counted number of times of imaging (that is, the number of times that a face area cannot be estimated) exceeds a threshold (ST408).

When the counted number of times of imaging exceeds the threshold (ST408, Yes), the authentication terminal 10 generates a face image in which the guide frame 30 having the standard size is superimposed on the captured image, and displays the face image on the display unit 15 (ST409).

On the other hand, when it is determined that the counted number of times of imaging (that is, the number of times that the face area cannot be estimated) does not exceed the threshold (ST408, No), the authentication terminal 10 generates a guidance message MSG12 for guiding the target person to a position where an image of the whole body of the target person can be captured, displays the guidance message MSG12 on the display unit 15 (ST410), and starts processing of step ST401 again. The message displayed in step ST410 is a message prompting the target person to move away from the authentication terminal 10 and move down to a position of a predetermined scale on a floor surface.

After step ST407 or step ST409, the authentication system 100 proceeds to processing of authenticating the target person.

As described above, the authentication system 100 according to Embodiment 3 can capture an image of the target person within a depth of field of the imaging unit 14A by displaying, on the display unit 15, the guide frame 30 generated in a size based on the area (size) of the face of the target person. The authentication system 100 can perform authentication using the captured image.

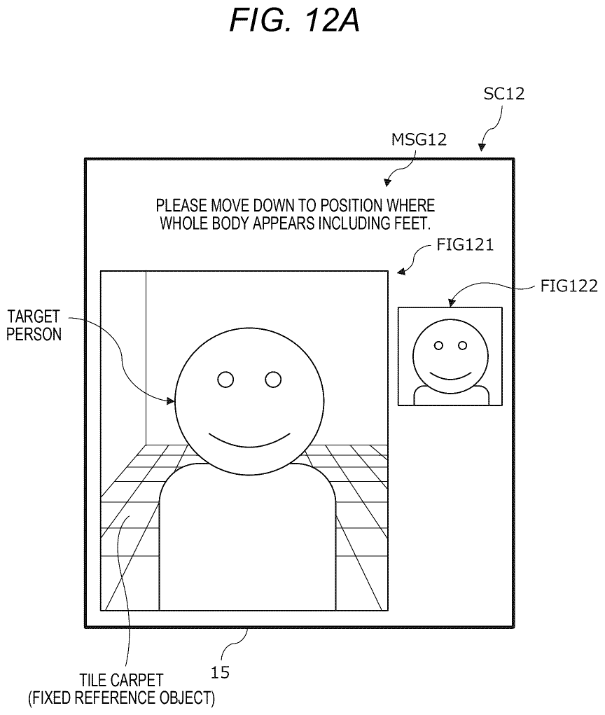

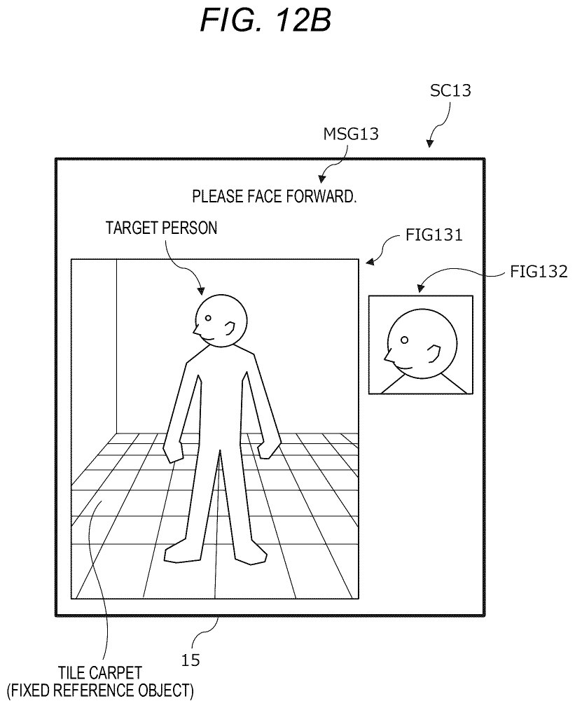

Here, an example of the guidance message MSG12 displayed in step ST410 or step ST510 will be described with reference to FIG. 12A. FIG. 12A is a diagram showing an example of a display screen SC12. The guidance message MSG12 and a fixed reference object shown in FIG. 12A are examples, and the present disclosure is not limited thereto.

The display screen SC12 is generated by the processor 20 and output (displayed) to the display unit 15. The display screen SC12 includes the guidance message MSG12, a captured image FIG121, and a cutout image FIG122. When it is determined that a whole body of a target person appears in the captured image FIG121, the processor 20 omits generation of the guidance message MSG12, generates the display screen SC12 not including the guidance message MSG12, and displays the display screen SC12 on the display unit 15.

The guidance message MSG12 is a message for guiding the target person to a position where an image of the whole body of the target person can be captured by the imaging unit 14A.

The captured image FIG121 is a captured image obtained by the imaging unit 14A. The cutout image FIG122 is an image obtained by cutting out a region showing the face of the target person from the captured image FIG121 and enlarging the region to a predetermined size by image analysis processing by the processor 20.

Further, in processing of step ST408 or step ST508, the processor 20 may determine whether a face direction of the target person shown in the captured image (that is, the captured image FIG121) obtained in step ST402 or step ST503 is a face direction suitable for estimating the area (size) of the face of the target person. In such a case, the processor 20 detects the face of the target person from the captured image FIG121, and estimates the face direction of the target person based on the detected face.

Here, an example of a guidance message MSG13 displayed in step ST410 or step ST510 will be described with reference to FIG. 12B. FIG. 12B is a diagram showing an example of a display screen SC13. The guidance message MSG13 and a fixed reference object shown in FIG. 12B are examples, and the present disclosure is not limited thereto.

The display screen SC13 is generated by the processor 20 and output (displayed) to the display unit 15. The display screen SC13 includes the guidance message MSG13, a captured image FIG131, and a cutout image FIG132. When it is determined that a face direction of a target person shown in the captured image FIG131 is the front, the processor 20 omits generation of the guidance message MSG13, generates the display screen SC13 not including the guidance message MSG13, and displays the display screen SC13 on the display unit 15.

The guidance message MSG13 is a message for guiding the face direction of the target person such that an image of a face of the target person can be captured from the front by the imaging unit 14A. The guidance message MSG13 may be output by voice from a speaker (not shown) or the like.

The captured image FIG131 is a captured image obtained by the imaging unit 14A. The cutout image FIG132 is an image obtained by cutting out a region showing the face of the target person from the captured image FIG131 and enlarging the region to a predetermined size by the image analysis processing by the processor 20.

### Modification of Embodiment 3

In the authentication system 100 according to Embodiment 3, the example has been described in which the area (size) of the face of the target person is estimated using the captured image obtained by capturing an image of the region including the whole body of the target person and the background, and the guide frame 30 is generated according to the area (size) of the face. In the authentication system 100 according to a modification of Embodiment 3, an example will be described in which an absolute distance between the authentication terminal 10 and a target person is measured using the positioning unit 13, and a size of the guide frame 30 is determined based on the measured absolute distance and a captured area (size) of a face of the target person.

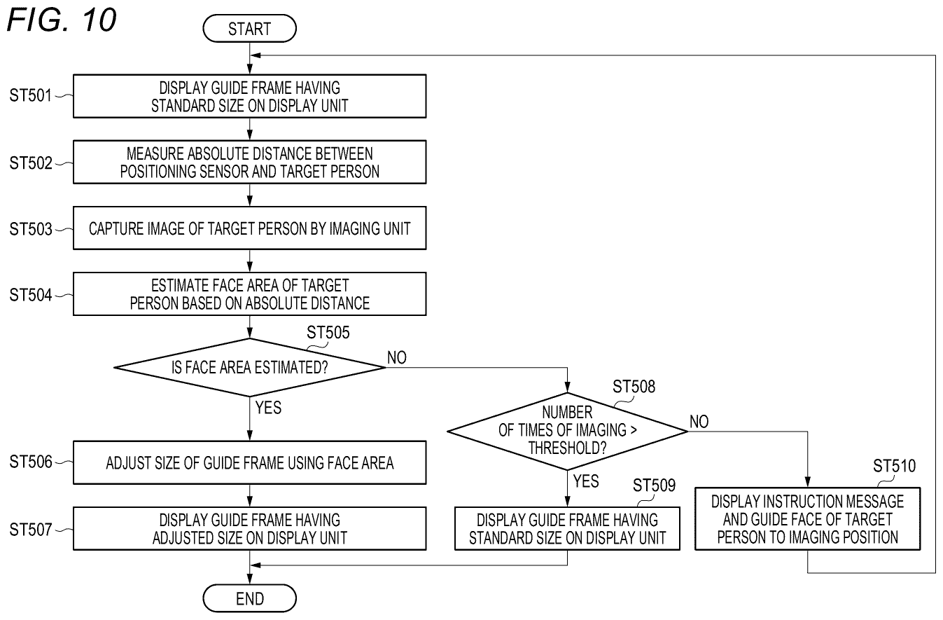

Hereinafter, the modification of Embodiment 3 will be described with reference to FIGS. 8C and 10. FIG. 8C is a diagram illustrating a use case of the authentication terminal 10 in the modification 1 of Embodiment 3. FIG. 8C shows an example in which the positioning unit 13 is attached to a lower side of the authentication terminal 10, but it goes without saying that an attachment position of the positioning unit 13 is not limited thereto.

Guide adjustment processing in the modification of Embodiment 3 will be described with reference to FIG. 10. FIG. 10 is a flowchart showing a guide adjustment processing example according to the modification of Embodiment 3.

The authentication terminal 10 displays, on the display unit 15, a captured image on which the guide frame 30 having a standard size is superimposed (ST501).

The authentication terminal 10 measures an absolute distance between the authentication terminal 10 (imaging unit 14A) and a target person by the positioning unit 13 (ST502). Specifically, the authentication terminal 10 acquires the absolute distance by calculating a distance between the imaging unit 14A and the target person based on a position (distance) of the target person measured by the positioning unit 13 and an attachment position of the positioning unit 13 with respect to the imaging unit 14A, which is set in advance.

The authentication terminal 10 captures an image of a face of the target person by the imaging unit 14A (ST503).

The authentication terminal 10 estimates an actual area (size) of the face of the target person based on the measured absolute distance and a proportion of the face of the target person in the captured image (ST504). In step ST504, the authentication terminal 10 may measure a height of the target person based on the absolute distance and a position of the face of the target person in the captured image.

The authentication terminal 10 determines whether the actual area (size) of the face of the target person is estimated (ST505). When it is determined that the actual area (size) of the face of the target person is estimated (ST505, Yes), the authentication terminal 10 determines a size of the guide frame 30 based on the estimated actual area (size) of the face of the target person. The authentication terminal 10 adjusts the size of the guide frame 30 (ST506).

The authentication terminal 10 generates a face image in which the guide frame 30 after the size adjustment is superimposed on the captured image, and displays the face image on the display unit 15 (ST507). Here, the authentication terminal 10 may change a position where the face image on which the guide frame 30 is superimposed is displayed on the display unit 15 based on the height of the target person.

On the other hand, when it is determined that the area (size) of the face cannot be estimated in step ST505 (ST505, No), the authentication terminal 10 determines whether the counted number of times of imaging of the target person by the imaging unit 14A (that is, the number of times that a face area cannot be estimated) exceeds a threshold (ST508).

When the counted number of times of imaging exceeds the threshold (ST508, Yes), the authentication terminal 10 generates a face image in which the guide frame 30 having the standard size is superimposed on the captured image, and displays the face image on the display unit 15 (ST509).

On the other hand, when it is determined that the counted number of times of imaging

(that is, the number of times that the face area cannot be estimated) does not exceed the threshold (ST508, No), the authentication terminal 10 generates a message for guiding a face direction of the target person such that an image of the face of the target person can be captured from the front, displays the message on the display unit 15 (ST510), and starts processing of step ST501 again. The message displayed in step ST510 is a message prompting the target person to move away from the authentication terminal 10 and move down to a position of a predetermined scale on a floor surface.

After step ST507 or step ST509, the authentication system 100 proceeds to processing of authenticating the target person.

As described above, the authentication system 100 according to the modification of Embodiment 3 can capture an image of the target person within a depth of field of the imaging unit 14A by displaying, on the display unit 15, the guide frame 30 generated in a size based on the area (size) of the face of the target person. The authentication system 100 can perform authentication using the captured image.

### Other Embodiments

Hereinafter, as other embodiments, configurations obtained by combining the above embodiments will be described.

As a combination example of the embodiments, Embodiment 1 and Embodiment 2 are combined. Specifically, first, according to the flowchart shown in FIG. 5, the identification of the target person is read, the attribute information is estimated from the read identification, the size of the guide frame 30 is determined, and the guide frame 30 is generated. Next, according to the flowchart shown in FIG. 7, the image of the face of the target person is captured by the imaging unit 14A, and the size of the guide frame 30 superimposed on the face image is updated using the captured image. Accordingly, even when the attribute information cannot be estimated from the identification (for example, step ST109, Yes), the authentication terminal 10 can display the guide frame 30 more suitable for authentication using the captured image of the target person.

As described above, the authentication terminal 10 (example of the authentication image acquisition device) according to Embodiment 2 includes the imaging unit 14A (example of the first imaging unit) configured to capture an image of a target person to be authenticated, the guide adjustment unit 27 (example of the generation unit) configured to generate a face image or a hand image (example of the guide image) in which the guide frame 30 (example of an imaging guide) for guiding the target person to an imaging position is superimposed on a captured image (example of a first captured image) obtained by the imaging unit 14A, the attribute estimation unit 21 (example of the acquisition unit) configured to acquire information on the target person (for example, attribute information on the target person or a size (area) of a face or a hand) based on the captured image, and the display unit 15 configured to display the face image or the hand image. The guide adjustment unit 27 is configured to generate the guide frame 30 having a size based on the information on the target person and superimpose the guide frame 30 on the captured image. Accordingly, the authentication terminal 10 can guide the target person to an imaging region or a distance at which the captured image more suitable for authentication can be obtained.

The imaging unit 14A of the authentication terminal 10 according to Embodiment 1 is configured to capture an image of the target person and an identification card of the target person. The attribute estimation unit 21 is configured to acquire the attribute information on the target person based on a captured image obtained by capturing an image of the identification card. Accordingly, based on the attribute information on the target person, the authentication terminal 10 can guide the target person to the imaging region or the distance at which the captured image more suitable for authentication can be obtained.

The authentication terminal 10 according to Embodiment 1 further includes the imaging unit 14B configured to capture an image of the identification card of the target person. The attribute estimation unit 21 is configured to acquire the attribute information on the target person based on a captured image (example of a second captured image) obtained by the imaging unit 14B. The guide adjustment unit 27 is configured to generate the guide frame 30 having a size based on the attribute information on the target person. Accordingly, based on the attribute information on the target person, the authentication terminal 10 can guide the target person to the imaging region or the distance at which the captured image more suitable for authentication can be obtained.

The authentication terminal 10 according to Embodiment 1 further includes the input unit 16 configured to receive an input operation performed by the target person regarding the attribute information on the target person. The attribute estimation unit 21 is configured to acquire the attribute information on the target person input to the input unit 16. Accordingly, based on the attribute information on the target person input from an input device, the authentication terminal 10 can guide the target person to the imaging region or the distance at which the captured image more suitable for authentication can be obtained.

The attribute estimation unit 21 of the authentication terminal 10 according to Embodiment 2 is configured to detect a face or a hand of the target person from the captured image of the target person, and acquire the attribute information on the target person based on the detected face or hand of the target person. Accordingly, the authentication terminal 10 can estimate the attribute information on the target person using a captured image of the face or the hand of the target person, and guide, based on an attribute of the target person, the target person to the imaging region or the distance at which the captured image more suitable for authentication can be obtained.

The authentication terminal 10 according to Embodiment 2 further includes the imaging unit 14B configured to capture an image of the target person, which is different from the imaging unit 14A. The attribute estimation unit 21 is configured to acquire the attribute information on the target person based on the captured image of the target person obtained by the imaging unit 14B. The guide adjustment unit 27 is configured to generate the guide frame 30 having a size based on the attribute information on the target person. Accordingly, the authentication terminal 10 can acquire a size of the face or the hand of the target person, and guide, based on the size of the face or the hand, the target person to the imaging region or the distance at which the captured image more suitable for authentication can be obtained.

The authentication terminal 10 according to Embodiment 3 further includes the imaging unit 14B configured to capture an image of the target person and a background. The attribute estimation unit 21 is configured to estimate a size of the face or the hand of the target person based on a position and a size of the target person with respect to a background of a second captured image obtained by the imaging unit 14B, and acquire the estimated size of the face or the hand. The guide adjustment unit 27 is configured to generate the guide frame 30 having a size based on the size of the face or the hand. Accordingly, the authentication terminal 10 can acquire the size of the face or the hand of the target person, and guide, based on the size of the face or the hand, the target person to the imaging region or the distance at which the captured image more suitable for authentication can be obtained.

In the authentication terminal 10 according to Embodiment 3, the attribute estimation unit 21 is configured to detect a fixed reference object (example of the fixed object) capable of estimating a distance between the authentication terminal 10 and the target person from the background of the second captured image obtained by the imaging unit 14B, and acquire the size of the face or the hand of the target person based on the distance based on the detected fixed reference object and the position and the size of the target person shown in the second captured image. Accordingly, the authentication terminal 10 can acquire the size of the face or the hand of the target person, and guide, based on the size of the face or the hand, the target person to the imaging region or the distance at which the captured image more suitable for authentication can be obtained.

The authentication terminal 10 according to the modification of Embodiment 3 further includes the positioning unit 13 (example of the measurement unit) configured to measure the distance between the authentication terminal 10 and the target person. The attribute estimation unit 21 is configured to acquire the size of the face or the hand of the target person based on the distance measured by the positioning unit 13 and the captured image of the target person. The guide adjustment unit 27 is configured to generate the guide frame 30 having a size based on the size of the face or the hand. Accordingly, the authentication terminal 10 can acquire the size of the face or the hand of the target person, and guide, based on the size of the face or the hand, the target person to the imaging region or the distance at which the captured image more suitable for authentication can be obtained.

Although various embodiments have been described above with reference to the drawings, it is needless to say that the present disclosure is not limited to such examples. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the various embodiments described above may be combined freely in a range without deviating from the spirit of the invention.

The present application is based on Japanese Patent Application No. 2022-121868 filed on Jul. 29, 2022, and the contents thereof are incorporated herein by reference.

### INDUSTRIAL APPLICABILITY

The present disclosure is useful as an authentication image acquisition device, an authentication image acquisition method, and an authentication image acquisition program that guide a target person to a position where a captured image more suitable for authentication can be obtained in acquisition of a captured image of the target person used for authentication.

### REFERENCE SIGNS LIST

10: authentication terminal

11: communication unit
12: memory
13: positioning unit
14A, 14B: imaging unit
15: display unit
16: input unit
20: processor
21: attribute estimation unit
22: image storage unit
25, 25A, 25B: data table
26: collation unit
27: guide adjustment unit
28: authentication unit
29: registration unit
30: guide frame
70: network
80: server
100: authentication system

1. An authentication image acquisition device comprising:
a first imaging unit that captures an image of a target person to be authenticated;
a generation unit that generates a guide image in which an imaging guide for guiding the target person to an imaging position is superimposed on a first captured image obtained by the first imaging unit;
an acquisition unit that acquires information on the target person based on the first captured image; and
a display unit that displays the guide image, wherein
the generation unit generates an imaging guide having a size based on the information on the target person and superimposes the imaging guide on the first captured image.

2. The authentication image acquisition device according to claim 1, wherein
the first imaging unit captures an image of the target person and an identification card of the target person, and
the acquisition unit acquires attribute information on the target person based on a captured image obtained by capturing an image of the identification card.

3. The authentication image acquisition device according to claim 1, further comprising:
a second imaging unit that captures an image of an identification card of the target person, wherein
the acquisition unit acquires attribute information on the target person based on a second captured image obtained by the second imaging unit, and
the generation unit generates an imaging guide having a size based on the attribute information on the target person.

4. The authentication image acquisition device according to claim 1, further comprising:
an input unit that receives an input operation performed by the target person regarding attribute information on the target person, wherein
the acquisition unit acquires the attribute information on the target person input to the input unit.

5. The authentication image acquisition device according to claim 1, wherein
the acquisition unit detects a face or a hand of the target person from a captured image of the target person and acquires attribute information on the target person based on the detected face or hand of the target person.

6. The authentication image acquisition device according to claim 1, further comprising:
a second imaging unit that captures an image of the target person, which is different from the first imaging unit, wherein
the acquisition unit acquires attribute information on the target person based on a captured image of the target person obtained by the second imaging unit, and
the generation unit generates an imaging guide having a size based on the attribute information on the target person.

7. The authentication image acquisition device according to claim 1, further comprising:
a second imaging unit that captures an image of the target person and a background, wherein
the acquisition unit estimates a size of a face or a hand of the target person based on a position and a size of the target person with respect to a background of a second captured image obtained by the second imaging unit, and acquire the estimated size of the face or the hand, and
the generation unit generates an imaging guide having a size based on the size of the face or the hand.

8. The authentication image acquisition device according to claim 7, wherein
the acquisition unit detects a fixed object capable of estimating a distance between the authentication image acquisition device and the target person from the background of the second captured image obtained by the second imaging unit, and acquires the size of the face or the hand of the target person based on the distance based on the detected fixed object and a position and a size of the target person shown in the second captured image.

9. The authentication image acquisition device according to claim 1, further comprising:
a measurement unit that measures a distance between the authentication image acquisition device and the target person, wherein
the acquisition unit acquires a size of a face or a hand of the target person based on the distance measured by the measurement unit and a captured image of the target person, and
the generation unit generates an imaging guide having a size based on the size of the face or the hand.

10. An authentication image acquisition method performed by an authentication image acquisition device, the authentication image acquisition device being configured to acquire a captured image obtained by capturing an image of a target person to be authenticated, the authentication image acquisition method comprising:
capturing an image of the target person;
acquiring information on the target person based on a captured image;
generating a guide image in which an imaging guide having a size based on the information on the target person and being for guiding the target person to an imaging position is superimposed on the captured image; and
displaying the guide image.

11. A computer readable storage medium on which an authentication image acquisition program for causing an authentication image acquisition device to execute processing is stored, the authentication image acquisition device including a computer capable of acquiring a captured image obtained by capturing an image of a target person to be authenticated, the processing including:
capturing an image of the target person;
acquiring information on the target person based on a captured image;
generating a guide image in which an imaging guide having a size based on the information on the target person and being for guiding the target person to an imaging position is superimposed on the captured image; and
displaying the guide image.
